(19) United States
(12) Patent Application Publication
(10) Pub. No.: US 2019/0384421 A1
(43) Pub. Date: Dec. 19, 2019

(54) LATENCY MASKING SYSTEMS AND METHODS

(71) Applicants: Bryan A. Cook, Silver Spring, MD (US); Thomas V. Trimeloni, Folsom, CA (US); Andong Zhan, Cumberland, MD (US); Daniel Simpkins, Bethesda, MD (US); Charles W.K. Gritton, Sterling, VA (US)

(72) Inventors: Bryan A. Cook, Silver Spring, MD (US); Thomas V. Trimeloni, Folsom, CA (US); Andong Zhan, Cumberland, MD (US); Daniel Simpkins, Bethesda, MD (US); Charles W.K. Gritton, Sterling, VA (US)

(21) Appl. No.: 16/550,881

(22) Filed: Aug. 26, 2019

Related U.S. Application Data
(63) Continuation of application No. 15/726,124, filed on Oct. 5, 2017.
Application No. 15/726,124 is a continuation of application No. 14/298,009, filed on Jun. 6, 2014, now abandoned.
(60) Provisional application No. 61/831,838, filed on Jun. 6, 2013.

(51) Int. Cl. G06F 3/0346; G06F 3/0354

(52) U.S. Cl. CPC G06F 3/0346; G06F 3/0354

(57) ABSTRACT

Systems and methods provide for removing and/or hiding the negative effects of at least some of the latency between, e.g., detection of motion of a device such as a three-dimensional (3D) pointing device and corresponding redrawing of the cursor on a display. A method for masking latency associated with displaying a cursor on a display includes: receiving data associated with motion of an input device at a first time; using the data to determine a cursor position associated with the first time; determining a predicted cursor position at a future time relative to the first time using the determined cursor position; and displaying the cursor on the display at a position based on the predicted cursor position.

### RELATED APPLICATIONS

This application is a continuation application of U.S. patent application Ser. No. 15/726,124, filed Oct. 5, 2017, which is a continuation application of U.S. patent application Ser. No. 14/298,009, filed Jun. 6, 2014, which is related to, and claims priority from, U.S. Provisional Patent Application Ser. No. 61/831,838 filed on Jun. 6, 2013, entitled “Latency Masking”, the disclosure of which is incorporated here by reference.

### BACKGROUND

The present invention describes latency masking techniques, systems, software and devices, which can be used in conjunction with user interfaces operating with three-dimensional (3D) pointing devices, as well as in other types of systems or user interfaces having other types of input devices.

Technologies associated with the communication of information have evolved rapidly over the last several decades. Television, cellular telephony, the Internet and optical communication techniques (to name just a few things) combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds, thousands, and potentially millions of channels of shows and information. Video-on-demand technology, currently used primarily in hotels and the like, provides the potential for in-home entertainment selection from among thousands of movie titles.

The technological ability to provide so much information and content to end users provides both opportunities and challenges to system designers and service providers. One challenge is that while end users typically prefer having more choices rather than fewer, this preference is counterweighted by their desire that the selection process be both fast and simple. Unfortunately, the development of the systems and interfaces by which end users access media items has resulted in selection processes which are neither fast nor simple. Consider again the example of television programs. When television was in its infancy, determining which program to watch was a relatively simple process primarily due to the small number of choices. One would consult a printed guide which was formatted, for example, as series of columns and rows which showed the correspondence between (1) nearby television channels, (2) programs being transmitted on those channels and (3) date and time. The television was tuned to the desired channel by adjusting a tuner knob and the viewer watched the selected program. Later, remote control devices were introduced that permitted viewers to tune the television from a distance. This addition to the user-television interface created the phenomenon known as “channel surfing” whereby a viewer could rapidly view short segments being broadcast on a number of channels to quickly learn what programs were available at any given time.

Despite the fact that the number of channels and amount of viewable content has dramatically increased, the generally available user interface, control device options and frameworks for televisions has not changed much over the last 30 years. Printed guides are still the most prevalent mechanism for conveying programming information. The multiple button remote control with up and down arrows is still the most prevalent channel/content selection mechanism. The reaction of those who design and implement the TV user interface to the increase in available media content has been a straightforward extension of the existing selection procedures and interface objects. Thus, the number of rows in the printed guides has been increased to accommodate more channels. The number of buttons on the remote control devices has been increased to support additional functionality and content handling, e.g., as shown in FIG. 1. However, this approach has significantly increased both the time required for a viewer to review the available information and the complexity of actions required to implement a selection. Arguably, the cumbersome nature of the existing interface has hampered commercial implementation of some services, e.g., video-on-demand, since consumers are resistant to new services that will add complexity to an interface that they view as already too slow and complex.

In addition to increases in bandwidth and content, the user interface bottleneck problem is being exacerbated by the aggregation of technologies. Consumers are reacting positively to having the option of buying integrated systems rather than a number of segregable components. An example of this trend is the combination television/VCR/DVD in which three previously independent components are frequently sold today as an integrated unit. This trend is likely to continue, potentially with an end result that most if not all of the communication devices currently found in the household will be packaged together as an integrated unit, e.g., a television/VCR/DVD/internet access/radio/stereo unit. Even those who continue to buy separate components will likely desire seamless control of, and interworking between, the separate components. With this increased aggregation comes the potential for more complexity in the user interface. For example, when so-called “universal” remote units were introduced, e.g., to combine the functionality of TV remote units and VCR remote units, the number of buttons on these universal remote units was typically more than the number of buttons on either the TV remote unit or VCR remote unit individually. This added number of buttons and functionality makes it very difficult to control anything but the simplest aspects of a TV or VCR without hunting for exactly the right button on the remote. Many times, these universal remotes do not provide enough buttons to access many levels of control or features unique to certain TVs.

In these cases, the original device remote unit is still needed, and the original hassle of handling multiple remotes remains due to user interface issues arising from the complexity of aggregation. Some remote units have addressed this problem by adding “soft” buttons that can be programmed with the expert commands. These soft buttons sometimes have accompanying LCD displays to indicate their action. These too have the flaw that they are difficult to use without looking away from the TV to the remote control. Yet another flaw in these remote units is the use of modes in an attempt to reduce the number of buttons. In these “moded” universal remote units, a special button exists to select whether the remote should communicate with the TV, DVD player, cable set-top box, VCR, etc. This causes many usability issues including sending commands to the wrong device, forcing the user to look at the remote to make sure that it is in the right mode, and it does not provide any simplification to the integration of multiple devices. The most advanced of these universal remote units provide some integration by allowing the user to program sequences of commands to multiple devices into the remote. This is such a difficult task that many users hire professional installers to program their universal remote units.

Some attempts have also been made to modernize the screen interface between end users and media systems. However, these attempts typically suffer from, among other drawbacks, an inability to easily scale between large collections of media items and small collections of media items. For example, interfaces which rely on lists of items may work well for small collections of media items, but are tedious to browse for large collections of media items. Interfaces which rely on hierarchical navigation (e.g., tree structures) may be speedier to traverse than list interfaces for large collections of media items, but are not readily adaptable to small collections of media items. Additionally, users tend to lose interest in selection processes wherein the user has to move through three or more layers in a tree structure. For all of these cases, current remote units make this selection processor even more tedious by forcing the user to repeatedly depress the up and down buttons to navigate the list or hierarchies. When selection skipping controls are available such as page up and page down, the user usually has to look at the remote to find these special buttons or be trained to know that they even exist. Accordingly, organizing frameworks, techniques and systems which simplify the control and screen interface between users and media systems as well as accelerate the selection process, while at the same time permitting service providers to take advantage of the increases in available bandwidth to end user equipment by facilitating the supply of a large number of media items and new services to the user have been proposed in U.S. patent application Ser. No. 10/768,432, filed on Jan. 30, 2004, entitled “A Control Framework with a Zoomable Graphical User Interface for Organizing, Selecting and Launching Media Items”, the disclosure of which is incorporated here by reference.

Of particular interest for this specification are the remote devices usable to interact with such frameworks, as well as other applications and systems. As mentioned in the above-incorporated application, various different types of remote devices can be used with such frameworks including, for example, trackballs, “mouse”-type pointing devices, light pens, etc. However, another category of remote devices which can be used with such frameworks (and other applications) is 3D pointing devices. The phrase “3D pointing” is used in this specification to refer to the ability of an input device to move in three (or more) dimensions in the air in front of, e.g., a display screen, and the corresponding ability of the user interface to translate those motions directly into user interface commands, e.g., movement of a cursor on the display screen. The transfer of data between the 3D pointing device may be performed wirelessly or via a wire connecting the 3D pointing device to another device. Thus “3D pointing” differs from, e.g., conventional computer mouse pointing techniques which use a surface, e.g., a desk surface or mousepad, as a proxy surface from which relative movement of the mouse is translated into cursor movement on the computer display screen. An example of a 3D pointing device can be found in U.S. Pat. No. 7,158,118 to Matthew G. Liberty, the disclosure of which is incorporated here by reference.

Many such systems have more latency than desired between motion initiation, e.g., a user moving a handheld, 3D pointing device, and the corresponding display update, e.g., updating the position at which to display the cursor on the display or TV. Examples of where high latency can occur include TV's with several frames of processing after the cursor is inserted, systems where the set-top box outside the TV generates the cursor, and cloud-based services where the motion response (e.g., cursor) is inserted remotely.

One approach to dealing with such latency is to reduce it by designing the hardware on which the system is operating having as a specific goal to minimize latency associated with the time between motion sensing and cursor redrawing. This can be an effective approach, but is not always implementation practical.

Accordingly, there is still room for improvement in the latency reduction or masking.

### SUMMARY

According to an embodiment, there is a method for masking latency associated with displaying a cursor on a display, the method comprising: receiving data associated with motion of an input device at a first time, using the data to determine a cursor position associated with the first time, determining a predicted cursor position at a future time relative to the first time using the determined cursor position and displaying the cursor on the display at a position based on the predicted cursor position.

According to an embodiment, there is a system for masking latency associated with displaying a cursor on a display, the system comprising: a device configured to receive data associated with motion of an input device at a first time; the device configured to use the data to determine a cursor position associated with the first time; the device configured to determine a predicted cursor position at a future time relative to the first time using the determined cursor position; and a display configured to display the cursor at a position based on the predicted cursor position.

According to an embodiment, there is a method for masking latency associated with displaying a graphic on a display, the method comprising: receiving data associated with motion of at least one object at a first time; using the data to determine a position associated with the first time; determining a predicted position at a future time relative to the first time using the determined position; and displaying the graphic on the display screen at a position based on the predicted position.

### BRIEF DESCRIPTION OF THE DRAWINGS

The accompanying drawings illustrate exemplary embodiments, wherein:

FIG. 1 depicts a conventional remote control unit for an entertainment system;

FIG. 2 depicts a media system in which embodiments can be implemented;

FIG. 3 shows a 3D pointing device according to an embodiment;

FIG. 4 illustrates a cutaway view of the 3D pointing device in FIG. 4 including two rotational sensors and one accelerometer according to an embodiment;

FIG. 5 shows a 3D pointing device according to another embodiment;

FIG. 6 depicts the 3D pointing device of FIG. 5 being used as part of a “10 foot” interface according to an embodiment;

FIG. 7 illustrates latency masking according to an embodiment;

FIG. 8 shows a process for converting raw data to an XY cursor position;

FIG. 9 illustrates a process for performing cursor prediction according to an embodiment;

FIG. 10 illustrates cursor mapping according to an embodiment;

FIG. 11 shows a process using predicting and mapping according to an embodiment;

FIG. 12 shows another process using predicting and mapping according to an embodiment;

FIG. 13 illustrates a logarithmic function associated with a scaling factor according to an embodiment;

FIG. 14 illustrates hardware elements of a pointing device according to an embodiment; and

FIG. 15 shows a flowchart of a method for masking latency according to an embodiment.

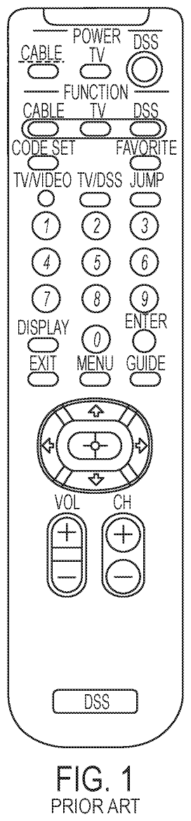

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Embodiments described herein operate to remove and/or hide the negative effects of at least some of the latency described above between, e.g., detection of motion of a device such as a three-dimensional (3D) pointing device or other pointing device and corresponding redrawing of the cursor on a display such as a TV. The result is a more responsive system.

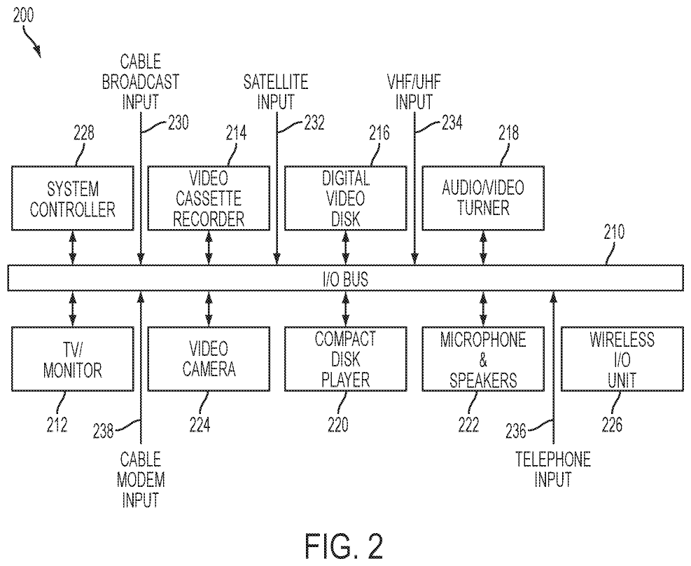

In order to provide some context for the discussion of these embodiments, an exemplary aggregated media system 200 in which the present invention can be implemented will first be described with respect to FIG. 2. Those skilled in the art will appreciate, however, that the present invention is not restricted to implementation in this type of media system and that more or fewer components can be included therein. Therein, an input/output (I/O) bus 210 connects the system components in the media system 200 together. The I/O bus 210 represents any of a number of different of mechanisms and techniques for routing signals between the media system components. For example, the I/O bus 210 may include an appropriate number of independent audio “patch” cables that route audio signals, coaxial cables that route video signals, two-wire serial lines or infrared or radio frequency transceivers that route control signals, optical fiber or any other routing mechanisms that route other types of signals.

In this exemplary embodiment, the media system 200 includes a television/monitor 212, a video cassette recorder (VCR) 214, digital video disk (DVD) recorder/playback device 216, audio/video tuner 218 and compact disk player 220 coupled to the I/O bus 210. The VCR 214, DVD 216 and compact disk player 220 may be single disk or single cassette devices, or alternatively may be multiple disk or multiple cassette devices. They may be independent units or integrated together. In addition, the media system 200 includes a microphone/speaker system 222, video camera 224 and a wireless I/O control device 226. According to exemplary embodiments of the present invention, the wireless I/O control device 226 is a 3D pointing device according to one of the exemplary embodiments described below. The wireless I/O control device 226 can communicate with the entertainment system 200 using, e.g., an IR or RF transmitter or transceiver. Alternatively, the I/O control device can be connected to the entertainment system 200 via a wire.

The entertainment system 200 also includes a system controller 228. According to one exemplary embodiment of the present invention, the system controller 228 operates to store and display entertainment system data available from a plurality of entertainment system data sources and to control a wide variety of features associated with each of the system components. As shown in FIG. 2, system controller 228 is coupled, either directly or indirectly, to each of the system components, as necessary, through I/O bus 210. In one exemplary embodiment, in addition to or in place of I/O bus 210, system controller 228 is configured with a wireless communication transmitter (or transceiver), which is capable of communicating with the system components via IR signals or RF signals. Regardless of the control medium, the system controller 228 is configured to control the media components of the media system 200 via a graphical user interface described below.

As further illustrated in FIG. 2, media system 200 may be configured to receive media items from various media sources and service providers. In this exemplary embodiment, media system 200 receives media input from and, optionally, sends information to, any or all of the following sources: cable broadcast 230, satellite broadcast 232 (e.g., via a satellite dish), very high frequency (VHF) or ultra high frequency (UHF) radio frequency communication of the broadcast television networks 234 (e.g., via an aerial antenna), telephone network 236 and cable modem 238 (or another source of Internet content). Those skilled in the art will appreciate that the media components and media sources illustrated and described with respect to FIG. 2 are purely exemplary and that media system 200 may include more or fewer of both. For example, other types of inputs to the system include AM/FM radio and satellite radio.

More details regarding this exemplary entertainment system and frameworks associated therewith can be found in the above-incorporated by reference U.S. patent application “A Control Framework with a Zoomable Graphical User Interface for Organizing, Selecting and Launching Media Items”. Alternatively, remote devices in accordance with the present invention can be used in conjunction with other systems, for example computer systems including, e.g., a display, a processor and a memory system or with various other systems and applications.

As mentioned in the Background section, remote devices which operate as 3D pointers are of particular interest for the present specification, although embodiments described herein are not limited to usage with 3D pointing devices. Such devices enable the translation of movement, e.g., gestures, into commands to a user interface. An exemplary 3D pointing device 400 is depicted in FIG. 3. Therein, user movement of the 3D pointing can be defined, for example, in terms of a combination of x-axis attitude (roll), y-axis elevation (pitch) and/or z-axis heading (yaw) motion of the 3D pointing device 400. In addition, some exemplary embodiments of the present invention can also measure linear movement of the 3D pointing device 400 along the x, y, and z axes to generate cursor movement or other user interface commands. In the exemplary embodiment of FIG. 3, the 3D pointing device 400 includes two buttons 402 and 404 as well as a scroll wheel 406, although other exemplary embodiments will include other physical configurations. According to exemplary embodiments of the present invention, it is anticipated that 3D pointing devices 400 will be held by a user in front of a display 408 and that motion of the 3D pointing device 400 will be translated by the 3D pointing device into output which is usable to interact with the information displayed on display 408, e.g., to move the cursor 410 on the display 408. For example, rotation of the 3D pointing device 400 about the y-axis can be sensed by the 3D pointing device 400 and translated into an output usable by the system to move cursor 410 along the y₂ axis of the display 408. Likewise, rotation of the 3D pointing device 408 about the z-axis can be sensed by the 3D pointing device 400 and translated into an output usable by the system to move cursor 410 along the x₂ axis of the display 408. It will be appreciated that the output of 3D pointing device 400 can be used to interact with the display 408 in a number of ways other than (or in addition to) cursor movement, for example it can control cursor fading, volume or media transport (play, pause, fast-forward and rewind). Input commands may include operations in addition to cursor movement, for example, a zoom in or zoom out on a particular region of a display. A cursor may or may not be visible. Similarly, rotation of the 3D pointing device 400 sensed about the x-axis of 3D pointing device 400 can be used in addition to, or as an alternative to, y-axis and/or z-axis rotation to provide input to a user interface.

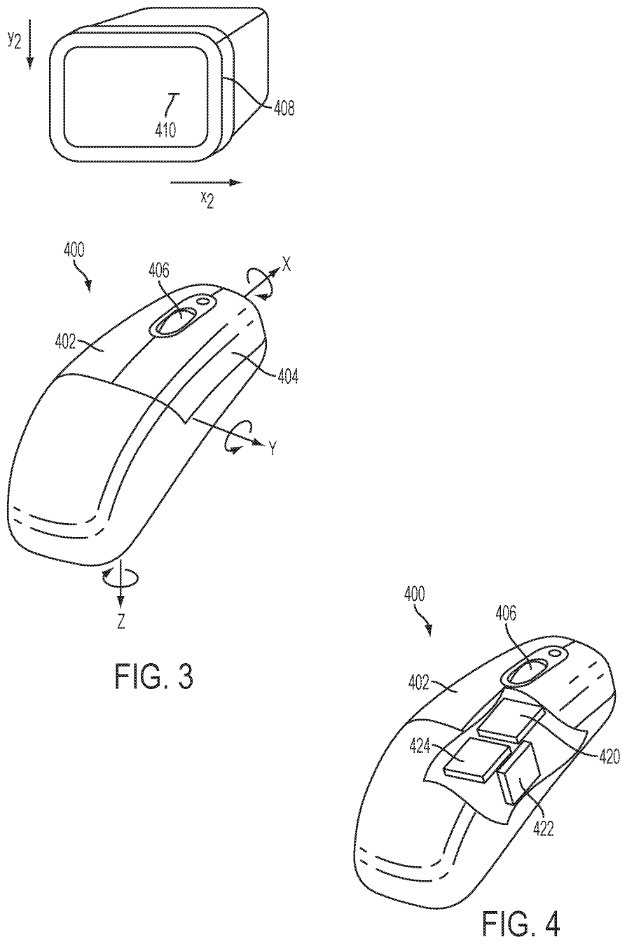

According to one purely illustrative exemplary embodiment of the present invention, two rotational sensors 420 and 422 and one accelerometer 424 can be employed as sensors in 3D pointing device 400 as shown in FIG. 4. Although this exemplary embodiment employs inertial sensors it will be appreciated that the present invention is not so limited and examples of other types of sensors which can be used in conjunction with other exemplary embodiments are provided below. The rotational sensors 420 and 422 can, for example, be implemented using ADXRS150 or ADXRS401 sensors made by Analog Devices. It will be appreciated by those skilled in the art that other types of rotational sensors can be employed as rotational sensors 420 and 422 and that the ADXRS150 and ADXRS401 are purely used as an illustrative example. Unlike traditional gyroscopes, these rotational sensors use MEMS technology to provide a resonating mass which is attached to a frame so that it can resonate only along one direction. The resonating mass is displaced when the body to which the sensor is affixed is rotated around the sensor's sensing axis. This displacement can be measured using the Coriolis acceleration effect to determine an angular velocity associated with rotation along the sensing axis. If the rotational sensors 420 and 422 have a single sensing axis (as for example the ADXRS150s), then they can be mounted in the 3D pointing device 400 such that their sensing axes are aligned with the rotations to be measured. For this exemplary embodiment of the present invention, this means that rotational sensor 422 is mounted such that its sensing axis is parallel to the y-axis and that rotational sensor 420 is mounted such that its sensing axis is parallel to the z-axis as shown in FIG. 4. It will be appreciated that different sensor packages may be available which could lead to other exemplary implementations. For example, the two one dimensional (1D) rotational sensors 420 and 422 could be replaced by a single, two dimensional (2D) rotational sensor package which provides outputs of rotational motion along, e.g., the y and z axes. One exemplary 2-D rotational sensor is the Invensense IDG-300, although it will be appreciated that other sensors/sensor packages may also be used. The rotational sensors 420, 422 can be 1-D, 2-D or 3-D sensors. The accelerometer 424 can, for example, be a 3-axis linear accelerometer, although a 2-axis linear accelerometer could be used by assuming that the device is measuring gravity and mathematically computing the remaining 3^{rd} value. Additionally, the accelerometer(s) and rotational sensor(s) could be packaged together into a single sensor package. Other variations of sensors and sensor packages may also be used in conjunction with these exemplary embodiments.

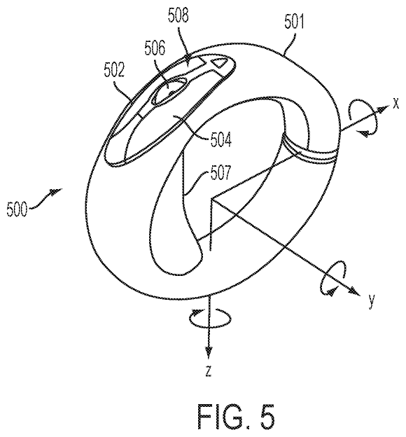

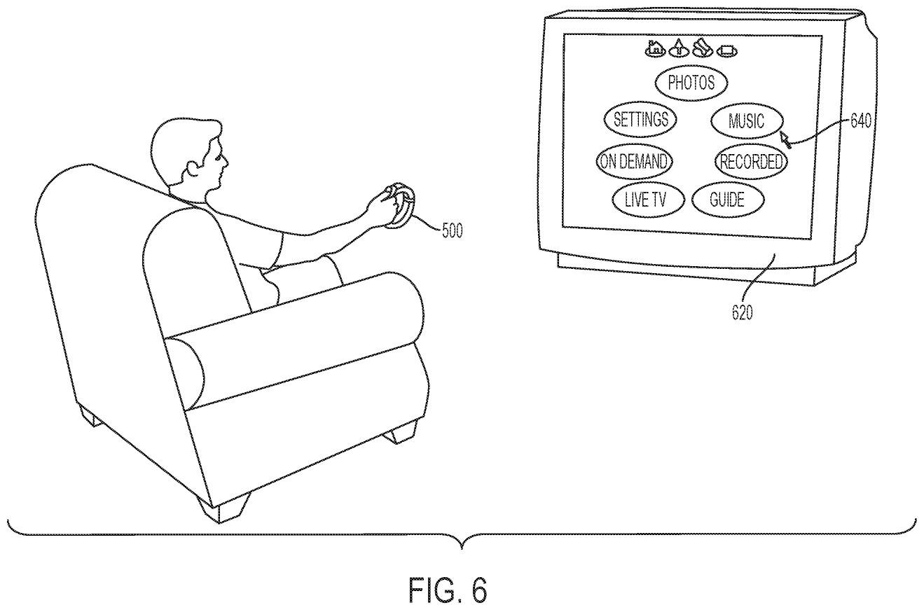

The exemplary embodiments are not limited to the industrial design illustrated in FIGS. 3 and 4, but can instead be deployed in any industrial form factor, another example of which is illustrated as FIG. 5. In the exemplary embodiment of FIG. 5, the 3D pointing device 500 includes a ring-shaped housing 501, two buttons 502 and 504 as well as a scroll wheel 506 and grip 507, although other exemplary embodiments may include other physical configurations. The region 508 which includes the two buttons 502 and 504 and scroll wheel 506 is referred to herein as the “control area” 508, which is disposed on an outer portion of the ring-shaped housing 501. More details regarding this exemplary embodiment can be found in U.S. patent application Ser. No. 11/480,662, entitled “3D Pointing Devices”, filed on Jul. 3, 2006, the disclosure of which is incorporated here by reference. Such devices have numerous applications including, for example, usage in the so-called “10 foot” interface between a sofa and a television in the typical living room as shown in FIG. 6. Therein, as the 3D pointing device 500 moves between different positions, that movement is detected by one or more sensors within 3D pointing device 200 and transmitted to the television 620 (or associated system component, e.g., a set-top box (not shown)). Movement of the 3D pointing device 500 can, for example, be translated into movement of a cursor 640 displayed on the television 620 and which is used to interact with a user interface. Details of an exemplary user interface with which the user can interact via 3D pointing device 500 can be found, for example, in the above-incorporated U.S. patent application Ser. No. 10/768,432 as well as U.S. patent application Ser. No. 11/437,215, entitled “Global Navigation Objects in User Interfaces”, filed on May 19, 2006, the disclosure of which is incorporated here by reference. However, as mentioned in the Background section above, in these types of systems (and others) there may be problems associated with cursor redraw latency, e.g., the time between when the motion sensor(s) in a pointing device detect motion of the device and when the system renders the cursor in a new position on the display or TV.

### Latency Masking

According to embodiments described below, such latency can be reduced or masked using one or more techniques associated with signal processing, human characteristics and/or visual aspects to provide higher system performance. One aspect of these embodiments is cursor position prediction which can result in a reduction of latency associated with cursor movement by a pointing device.

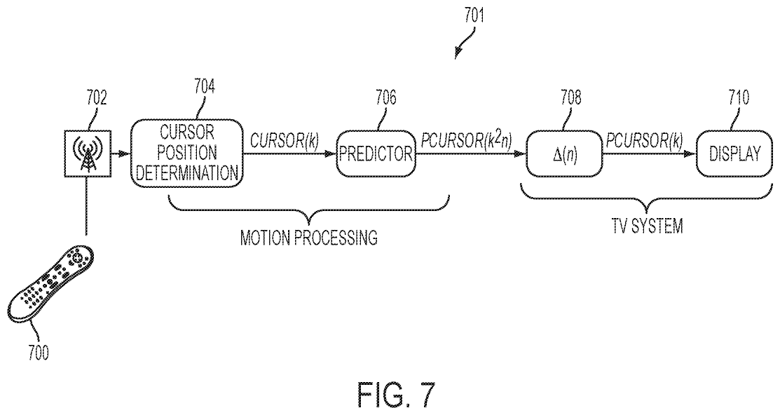

Referring now to FIG. 7, an embodiment of latency/cursor position prediction is illustrated. Therein a pointing device 700, e.g., the 3D pointing device 400 such as those described above or other handheld pointing device, communicates sensed or detected motion of the device 700 and communicates data associated with the sensed or detected motion to a user interface (UI) system 701, e.g., cloud-based, set-top box based, TV-based, computer-based, etc., which has a wireline or wireless communication interface 702. In this example, the system 701 can be considered to have one or more processing/software modules associated with generating a new cursor position based on the received motion data, e.g., cursor position determination module 704 which generates a new cursor position based on the received data and a cursor predictor module 706 which generates a predicted cursor position at some time in the future. In this example, the system 701 has some predetermined overall processing delay associated with redrawing the cursor which is referred to herein as “n” frames and is represented by block 708. The processing which occurs downstream of the motion data processing receives the predicted cursor position, which in this example is predicted for “n” frames into the future, delays the rendering of the cursor by “n” frames due to the latency associated with various other processes, and then draws the cursor at the predicted position on the display 710.

By predicting the position of the cursor n frames into the future, embodiments can reduce or eliminate the effects of processing latency on displayed cursor position. The embodiments need not, however, counteract all of the latency. Thus, instead of predicting the cursor position “n” frames into the future, embodiments can more generally predict the position or the path of the cursor n−1 frames into the future. The cursor position to be displayed is then adjusted a bit so that the gap between the position of the cursor now and the predicted position of the cursor in the future is narrowed. The amount of that narrowing is a systems parameter that can be set, e.g., by the application running on the system 701, by the system 701 itself and/or by the user. For full prediction, the future predicted cursor position is used with no adjustment. For no prediction, the current cursor position is used with no adjustment. In between, a mix of the two, i.e., full prediction and no prediction, can be used so that the predicted cursor position is taken into account.

According to an embodiment, a double exponential smoothing algorithm (or algorithms) can be used in predictive tracking to reduce cursor latency experienced by the user. The double exponential smoothing algorithms used herein can be considered to be a class of Autoregressive Integrated Moving Average (ARIMA) models. An example of this double exponential smoothing algorithm is shown below in Equations (1)-(3):

sₜ=αxₜ+(1−α)(sₜ₋₁+bₜ₋₁) (1)

bₜ=β(sₜ−sₜ₋₁)+(1−β)bₜ₋₁ (2)

Fₜ₊ₘ=sₜ+mbₜ (3)

Where α is the data smoothing factor, β is the trend smoothing factor, x is the raw data, s is the smoothed data, b is the trend estimate, and t is the time index. F is the forecasted data that is valid m units of time into the future from t. When less smoothing is desired, larger values of a and β can be used. When more smoothing is desired, smaller values of α and β can be used. According to an embodiment, α and β can be of a same or similar value when using double exponential smoothing for predicting cursor movement. One example of a range of values for α and β can be the range 0.2 to 0.4 however, other ranges of values can be used. α can further be described in that a controls how aggressive latency reduction can be. For example, when a has a value approaching one, the cursor is responsive but jumpy as experienced by a user. When a has a value approaching zero, the cursor is smooth but sluggish as experienced by a user.

According to an embodiment, double exponential smoothing for predicting cursor movement to reduce latency can use less processing power and/or processing time as compared to a more traditional method of smoothing, e.g., a Kalman filter, while providing a similar amount of predictive accuracy. In other words, according to an embodiment, one could consider the double exponential smoothing to be an order of magnitude simpler than a conventional Kalman Filter when predicting cursor movement to reduce latency.

According to an embodiment, when three-dimensional rotation is involved in creating latency with respect to cursor motion, e.g., when quaternion calculations are involved, spherical linear interpolation can be applied to the data prior to applying smoothing as described in various embodiments herein.

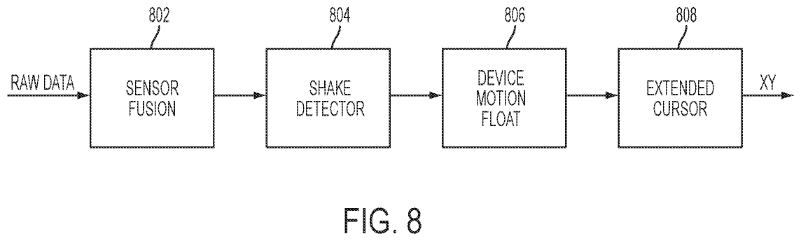

According to an embodiment, the typical process for converting raw data to an XY cursor position is shown in FIG. 8. Raw data associated with pointing device 700's motion to move a cursor on a display is received and processed by undergoing the processing steps of: sensor fusion 802, which outputs sensor and position data to the shake detector 804, which outputs sensor and position data to device motion float 806, which outputs relevant cursor data to extended cursor 808 resulting in a cursor location output for display, e.g., an XY position on a display.

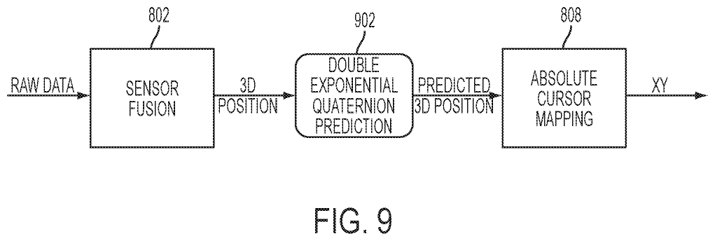

According to an embodiment, a process for performing prediction in the cursor predictor module 706 is shown in FIG. 9. Raw data associated with device motion to move a cursor is received and processed by undergoing the processing steps of: sensor fusion 802 which fuses raw sensor data into 3D quaternion position information and outputs sensor and position data, Double Exponential Quaternion Prediction 902 which predicts a future quaternion given the current device quaternion, and Absolute Cursor Mapping 808 which maps 3D data to 2D cursor data. This results in a predicted cursor location output for display, e.g., an XY position on the display.

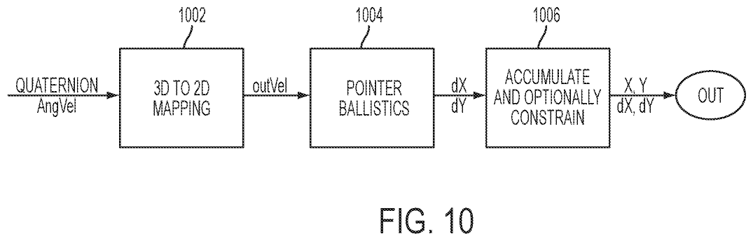

According to embodiment, the processing that occurs for Absolute Cursor Mapping 808 can be performed and/or modified in various methods as is now described with respect to FIGS. 10-12. Additionally, more information associated with Absolute Cursor Mapping can be found in U.S. patent application Ser. No. 13/000,889 entitled “3D Pointer Mapping”, which is incorporated here by reference. Initially, as shown in FIG. 10, 3D to 2D Mapping 1002 maps 3D angular velocity data to 2D cursor velocity data, Pointer Ballistics function 1004 processes the 2D velocity data with non-linear ballistics mapping, and Accumulate and Optionally Constrain function 1006 which maps the received velocity information to a cursor location for display, e.g., an XY position on the display, that is optionally bounded for relative or absolute pointing. Where relative pointing allows for pointing within the bounds of the display, while being agnostic of the beginning orientation of the pointing device 700. Absolute pointing accounts for the orientation of the device 700, keeping the pointer aligned with the device analogous to a laser pointer.

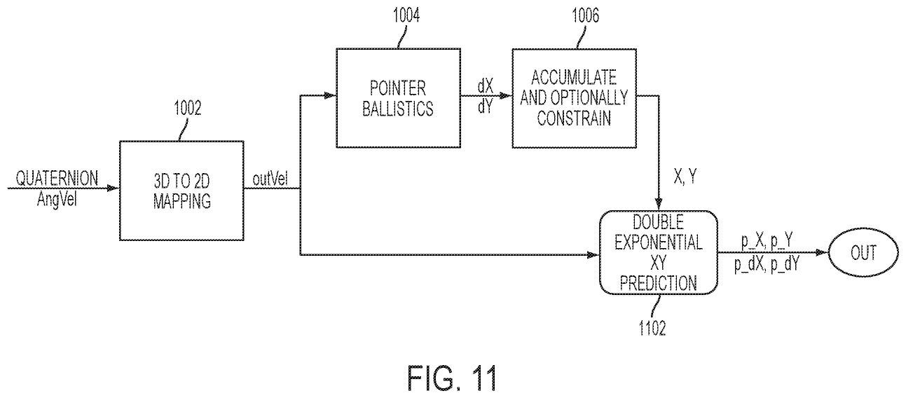

According to an embodiment, as shown in FIG. 11, the Absolute Cursor Mapping 808 can be used for another prediction technique. 3D to 2D Mapping 1002 maps 3D angular velocity data to 2D cursor velocity data. The data is fed into Pointer Ballistics function 1004 which performs non-linear ballistic mapping on the velocity data, and Accumulate and Optionally Constrain function 1006 then maps the velocity data to cursor XY position information. The position information from the Accumulate and Optionally Constrain function 1006 and the 2D cursor velocity data from 3D to 2D Mapping 1002 is processed by Double Exponential XY Prediction 1102, which in turn produces predicted cursor information for display, e.g., an XY position on the display. According to an embodiment, Double Exponential XY Prediction 1102 applies the above described double exponential smoothing methods to XY coordinate information.

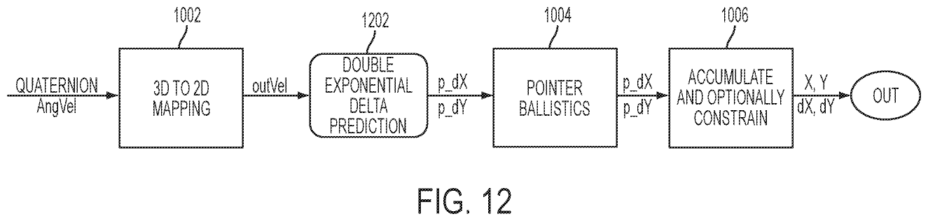

According to another embodiment, as shown in FIG. 12, the Absolute Cursor Mapping 808 can include 3D to 2D Mapping 1002 which maps 3D angular velocity data to 2D cursor velocity data, a Double Exponential Delta Prediction function 1202 which uses the received 2D cursor velocity data to produce predicted cursor velocity data. If the cursor is thought of as a ballistic object, then it is natural to assign a velocity, or rate of change, to it as it moves in the X and Y directions on the screen. The Double Exponential Delta Prediction function 1202 applies double exponential smoothing, as described above, to this XY velocity information. This predicted cursor velocity data can then be forwarded to Pointer Ballistics function 1004 which performs non-linear ballistic mapping on the received predicted velocity data to produce a new, modified velocity data. This modified velocity data can then be processed by Accumulate and Optionally Constrain function 1006 which maps the modified velocity data to cursor information for display, e.g., an XY position on the display.

The afore-described cursor position/path prediction techniques can be used by itself to mask latency associated with updating display of a moving cursor based on detected input device motion. Alternatively, one or more additional techniques can be used to further improve the performance.

For example, when motion of the 3D pointing device 400 first begins, the inertial sensors detect the motion right away. The display though doesn't indicate the motion until N frames later due to latency as described above. To mask latency at the beginning of motion, one or more other approaches can be used either with or as alternatives to prediction. For example, it may be important that the user gets immediate feedback that the movement of the 3D pointing device 400 is being processed by the system. Therefore, one of the components of latency masking according to these embodiments can be the provision of a vibration and/or sound signal, e.g., emanating from the handheld input device, that is a user feedback to the 3D pointing device 400 beginning its motion, i.e., this feedback only occurs for a brief, predetermined time period at the beginning of device/cursor motion to signal to the user that the system is responding. However, it can occur during the initial latency period, e.g., N−1 frame periods, during which the cursor is not yet moving on the display.

A second approach is to visually mask the start of motion. This can be done in many ways but one way to visually mask the start of motion is to have a cursor that is visually modulating or vibrating on the display in all directions subtly. This visual masking at the start of motion can alternatively be described as introducing a redrawing of the cursor on the screen that is not directly generated by the sensed motion and which is drawn on the display or TV during all or part of the n frame latency period. The fact that this vibration is asynchronous and independent of the movement can mask some of the latency.

Another aspect of latency masking involves end of motion latency masking. When motion stops, the inertial sensor(s) in the 3D pointing device or other input device detect this almost immediately. However, the display will not fully indicate this stoppage of motion until N frames later. This is also known as “overshoot” or “overshooting”. The purpose of this embodiment is to mask this delay associated with motion stoppage. There are several options here as well. One option to mask this delay incorporates target knowledge and combines that knowledge with trajectory projections and virtual wells to predictively capture the cursor on the target. For systems that do not have target knowledge, these systems nonetheless do have predictive region knowledge, i.e., the general area where the user is sending the cursor. The system can then build a virtual gravity well around that area as well to capture the cursor around the intended target. As the cursor approaches a certain distance from the well, the cursor begins to become attracted to the well and is gradually moved towards it. Also, or alternatively, the system can blur or defocus the cursor during motion with a purposeful focusing after the cursor stops moving. Done correctly, the user will attribute the lag to the visual nature of the UI and not to the lag in responsiveness of the system.

According to an embodiment, a method for reducing overshooting involves using a scaling function on the cursor movement prediction. For example, to reduce overshooting and exaggeration of small movements, prediction can be stopped when the cursor is not moving. However, using a scaling function in a binary, step function type on/off manner could generate a poor user experience. An example of a prediction equation in which a scaling function can be used is shown below in Equation (4).

Fₜ=sₜ+sfₜ*m*bₜ (4)

Where Fₜ is the predicted stated, sₜ is the current state, sfₜ is the scaling factor which exists in the interval (0,1] at time t, m is the prediction interval in seconds, and bₜ is the trend estimate from Equation (2). However, using a scaling function in a binary, step function type on/off manner could generate a poor user experience.

According to an embodiment an interval of time, called herein a “pinterval” which is the prediction interval in seconds, can be multiplied by a scaling term ranging from zero to one. This can create the effect of gradual deceleration or of gradual acceleration of the cursor movement for the user as a pointer slows down or speed up, respectively. According to an embodiment, if the pinterval and scaling factor causes the predicted data to fall between samples sent for display, e.g., the predicted location doesn't align in time with the display frame, then interpolation can be used to ascertain the correct location at the correct time. Two states are predicted, one slightly before the desired frame and one slightly after the desired frame, and then the actual predicted location for the display frame will be the interpolated result of the two predicted states.

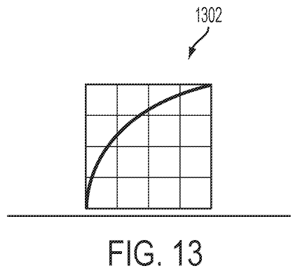

According to an embodiment, the scaling factor can be calculated using a logarithmic function. A graphic example of the logarithmic function 1302 is shown in FIG. 13. An example of equation for calculating the scaling function (sf) using the logarithmic function is shown below in Equation (5).

$${sf}_{t} = max ( min ( \frac{log ( {d}_{t} )}{log ( λ )} , 1 ) , ɛ ) \qquad ( 5 )$$

Where sfₜ is the scaling factor, dₜ is the Euclidian distance in pixels between the cursor's current position and the cursor's previous position at time t, λ, is the base used to determine how quickly the scaling factor increases, and ε is the smallest non-zero positive number that the computer can represent. Alternatively, a so-called “linear reward inaction scheme” could also be used, an example of which is shown in Equations (6) and (7).

sfₜ=sdₜ₋₁+α_{I}(1−sfₜ) (6)

and

sfₜ=sfₜ₋₁+α_{A}(1−sfₜ₋₁) (7)

Where sfₜ is the new scaling factor, sfₜ₋₁ is the old scaling factor, and α₁ is the rate of change used for the inaction state, and α_{A} is the rate of change for the action state. For example, the inaction state could be used when the cursor is slowing down, and the action state could be used when the cursor is speeding up. Since Equations 6 and 7 have a ‘state’ in that their current output depends on the previous output of sfₜ, this allows for a different scaling factor curve when the user is speeding up than when the user is slowing down.

According to an embodiment, yet another feature which can be combined with any of the foregoing to assist with latency removal or masking is to forecast and remove the user's hand tremor motion from the data. For example, the user's tremor patterns can be identified and removed from the motion being predicted. Examples of tremor identification and/or removal can be found in, for example, U.S. Pat. No. 7,236,156, the disclosure of which is incorporated here by reference.

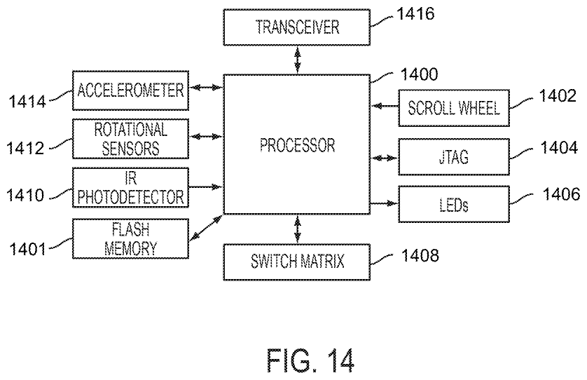

Having provided a description of latency masking in systems including pointing devices 700, e.g., 3D pointing devices 400, according to the afore-described exemplary embodiments, FIG. 14 illustrates an exemplary hardware architecture associated with such pointing devices 700. Therein, a processor 1400 communicates with other elements of the pointing device including a flash memory 1401, scroll wheel 1402, JTAG 1404, LEDs 1406, switch matrix 1408, IR photodetector 1410, rotational sensor(s) 1412, accelerometer 1414 and transceiver 1416. The flash memory device 1401 can be used by processor 1400 to store various programs and/or data for use in operating the pointing device, e.g., bias estimates as described above. The scroll wheel 1402 is an optional input component which enables a user to provide input to the interface by rotating the scroll wheel 1402 clockwise or counterclockwise. JTAG 1404 provides the programming and debugging interface to the processor. LEDs 1406 provide visual feedback to a user, for example, when a button is pressed. Switch matrix 1408 receives inputs, e.g., indications that a button on the pointing device has been depressed or released, that are then passed on to processor 1400. The optional IR photodetector 1410 can be provided to enable the exemplary free space pointing device to learn IR codes from other remote controls. Rotational sensors 1412 provide readings to processor 1400 regarding, e.g., the y-axis and z-axis rotation (angular rate) of the pointing device as described above. Accelerometer 1414 provides readings to processor 1400 regarding the linear acceleration of the pointing device which can be used, e.g., to perform tilt compensation and to compensate for errors which linear acceleration introduces into the rotational readings generated by rotational sensor(s) 1412. Transceiver 1416 is used to communicate information to and from pointing device, e.g., to the system controller 228 or to a processor associated with a computer. The transceiver 1416 can be a wireless transceiver, e.g., operating in accordance with the Bluetooth standards for short-range wireless communication or an infrared transceiver. Alternatively, pointing device 700 which may be a 3D pointing device according to these embodiments can communicate with systems via a wireline connection.

The individual latency masking techniques described above can be used and applied independently of one another or in different combinations. More specifically, and for completeness, exemplary embodiments contemplate systems with each combination of latency masking techniques listed in the table below. This list is not, however, intended to be exhaustive and, in fact, any combination or permutation of types 1-6 below is intended to be included.

| Com- | |
|---|---|
| bination | Type(s) of Latency Masking Systems or Techniques |
| 1 | Cursor Position Prediction Only, Optionally With One or More |
| | of the Embodiments shown in FIGS. 10-12. |
| 2 | Begin Motion Masking With Start Feedback Only |
| 3 | Begin Motion Masking With Visual Masking Only |
| 4 | End Motion Masking With Predictive Cursor Capture Only |
| 5 | End Motion Masking With Refocusing Cursor Only |
| 6 | Tremor Removal Only |
| 7 | 1, 2, 3, 4, 5 and 6 |
| 8 | 1, 2, 3, 4, and 5 |
| 9 | 1, 2, 3, and 4 |
| 10 | 1, 2, and 3 |
| 11 | 1 and 2 |
| 12 | 1 and 3 |
| 13 | 1 and 4 |
| 14 | 1 and 5 |
| 15 | 1 and 6 |
| 16 | 1, 3, 4 and 5 |

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within the device, e.g., a 3D pointing device or other device, which contains the sensors or the software may run on a processor or computer housed within another device, e.g., the system controller 228, a game console, a personal computer, a set-top box, etc., which is in communication with the device containing the sensors. In such a case, data may be transferred via wireline or wirelessly between the device containing the sensors and the device containing the processor which runs the software which performs the latency masking as described above. According to other exemplary embodiments, some of the processing described above with respect to latency masking may be performed in the device containing the sensors, while the remainder of the processing is performed in a second device, e.g., the system controller 228, a game console, a personal computer, a set-top box, etc., after receipt of the partially processed data from the device containing the sensors.

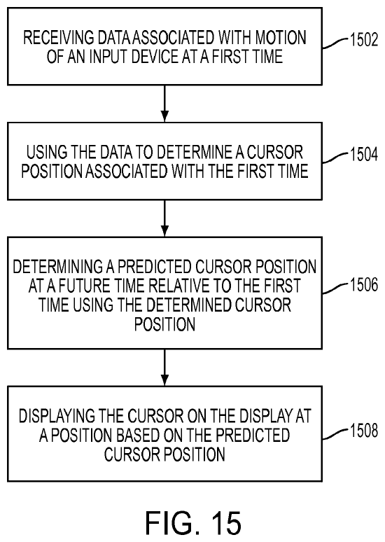

Utilizing the above-described systems according to an embodiment, there is a method for masking latency associated with displaying a cursor on a display or a screen as shown in the flowchart of FIG. 15. Initially the method for masking latency associated with displaying a cursor on a display includes: receiving data associated with motion of an input device at a first time in step 1502; using the data to determine a cursor position associated with the first time in step 1504; determining a predicted cursor position at a future time relative to the first time using the determined cursor position in step 1506; and displaying the cursor on the display screen at a position based on the predicted cursor position in step 1508.

Although the foregoing exemplary embodiments relate to sensing packages including one or more rotational sensors and an accelerometer, latency masking techniques according to these exemplary embodiments are not limited to only these types of sensors. Instead latency masking techniques as described herein can be applied to devices which include, for example, only accelerometer(s), optical and inertial sensors (e.g., a rotational sensor, a gyroscope or an accelerometer), a magnetometer and an inertial sensor (e.g., a rotational sensor, a gyroscope or an accelerometer), a magnetometer and an optical sensor, or other sensor combinations. Additionally, although exemplary embodiments described herein relate to latency masking in the context of 3D pointing devices and applications, such techniques are not so limited and may be employed in methods and devices associated with other applications, e.g., medical applications, gaming, cameras, military applications, etc.

For example, in Head Mounted Displays, one might want to adjust the displayed point of view (with or without any marking) rather than a displayed cursor screen location using these latency masking techniques. As another example, in some gaming applications, one might want to adjust the 3D position of a cursor (or displayed point of view with or without marking) using these latency masking techniques. As yet another example, in some pedestrian dead reckoning (PDR) applications, one may want to adjust the tracking location or velocity or map matching alternatives or particle filtering streams using these latency masking techniques. In short, these same above described techniques can be applied to many different scenarios. Appropriate systems can be used which include, but are not limited to, processors, memory, head mounted gear, displays, sensors associated with motion and communication links can be provided to support such methods.

Additionally, embodiments described herein for predicting motion can further be used to mask latency associated with motion, processing of the motion and a displayed output or graphic associated with both the motion and processing the motion. For example, when using a head mounted device or display, motion associated with such can benefit from the above described embodiments, e.g., double exponential smoothing algorithms for predicting motion. These concepts can further be used in augmented reality systems and virtual reality systems to provide latency reduction for displayed graphics associated with motion by, for example, a user wearing or holding a device which interacts with augmented reality systems and/or virtual reality systems. These can be either 2D or 3D systems. Additionally, a marker can be displayed on a display which indicates the center of the point of view. According to another embodiment, an independent cursor can be overlaid on the same display which can benefit from an optional second latency masking system. Furthermore, one could have a system in which multiple users are exhibiting motions which become displayed, all of which could have their own independent latency masking system using the embodiments described above associated with prediction and latency masking. Appropriate systems can be used which include, but are not limited to, processors, memory, displays, virtual reality gear, sensors associated with motion and communication links can be provided to support such methods.

The above-described exemplary embodiments are intended to be illustrative in all respects, rather than restrictive, of the present invention. Thus, the present invention is capable of many variations in detailed implementation that can be derived from the description contained herein by a person skilled in the art. For example, although the foregoing exemplary embodiments describe, among other things, the use of inertial sensors to detect movement of a device, other types of sensors (e.g., ultrasound, magnetic or optical) can be used instead of, or in addition to, inertial sensors in conjunction with the afore-described signal processing. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for masking latency associated with displaying a cursor on a display, the method comprising:
receiving data associated with motion of an input device at a first time;
using the data to determine a cursor position associated with the first time;
determining a predicted cursor position at a future time relative to the first time using the determined cursor position; and
displaying the cursor on the display screen at a position based on the predicted cursor position.

2. The method of claim 1, wherein determining the predicted cursor position further comprises:
using a double exponential smoothing algorithm which includes a data smoothing factor and a trend smoothing factor.

3. The method of claim 1, wherein determining the predicted cursor position further comprises:
processing raw sensor data into three-dimensional (3D) quaternion position information;
predicting a future quaternion; and
mapping 3D data to two-dimensional (2D) cursor data.

4. The method of claim 3, wherein mapping 3D data to 2D cursor data further comprises:
mapping 3D angular velocity data to 2D cursor velocity data;
processing the 2D cursor velocity data with non-linear ballistics mapping to produce an output of velocity information; and
mapping the output of velocity information to a cursor location.

5. The method of claim 4, further comprising:
processing with a double exponential prediction algorithm the 2D cursor velocity data and the cursor location with a double exponential prediction algorithm to generate predicted cursor information for display.

6. The method of claim 3, wherein mapping 3D data to 2D cursor data further comprises:
mapping 3D angular velocity data to 2D cursor velocity data;
processing the 2D cursor velocity data with a double exponential delta prediction process which produces a predicted cursor velocity data;
processing the predicted cursor velocity data with non-linear ballistic mapping to produce a modified velocity data; and
mapping the modified velocity data to cursor information for display.

7. The method of claim 1, further comprising:
visually masking a start of motion for the cursor on the display by at least one of modulating and vibrating the cursor on the display in a plurality of directions.

8. The method of claim 1, further comprising:
masking cursor motion associated with motion stoppage of the input device on the display.

9. The method of claim 8, wherein masking cursor motion associated with motion stoppage of the input device on the display further comprises:
predictively capturing an ending position of the cursor.

10. The method of claim 1, further comprising:
reducing an overshoot distance wherein the overshoot distance is a distance the cursor moves on the display after the input device stops moving by using a prediction equation which includes a scaling function.

11. The method of claim 1, wherein the input device is a 3D pointing device.

12. The method of claim 1, wherein the device is at least one of a set-top box, a gaming console, a system controller, a personal controller and the input device.

13. A system for masking latency associated with displaying a cursor on a display, the system comprising:
a device configured to receive data associated with motion of an input device at a first time;
the device configured to use the data to determine a cursor position associated with the first time;
the device configured to determine a predicted cursor position at a future time relative to the first time using the determined cursor position; and
the display configured to display the cursor at a position based on the predicted cursor position.

14. The system of claim 13, further comprising:
the device configured to use a double exponential smoothing algorithm which includes a data smoothing factor and a trend smoothing factor when determining the predicted cursor position.

15. The system of claim 13, further comprises:
the device configured to process raw sensor data into three-dimensional (3D) quaternion position information;
the device configured to predict a future quaternion; and
the device configured to map 3D data to two-dimensional (2D) cursor data when determining the predicted cursor position.

16. The system of claim 15, further comprising:
the device configured, when mapping 3D data to 2D cursor data, to map 3D angular velocity data to 2D cursor velocity data;
the device configured to process the 2D cursor velocity data with non-linear ballistics mapping to produce an output of velocity information; and
the device configured to map the output of velocity information to a cursor location.

17. The system of claim 16, further comprising:
the device configured to process with a double exponential prediction algorithm the 2D cursor velocity data and the cursor location with a double exponential prediction algorithm to generate predicted cursor information for display.

18. The system of claim 15, further comprising:
the device configured, when mapping 3D data to 2D cursor data, to map 3D angular velocity data to 2D cursor velocity data;
the device configured to process the 2D cursor velocity data with a double exponential delta prediction process which produces a predicted cursor velocity data;
the device configured to process the predicted cursor velocity data with non-linear ballistic mapping to produce a modified velocity data; and
the device configured to map the modified velocity data to cursor information for display.

19. The system of claim 13, further comprising:
the device configured to visually mask a start of motion for the cursor on the display by at least one of modulating and vibrating the cursor on the display in a plurality of directions.

20. The system of claim 13, further comprising:
the device configured to mask cursor motion associated with motion stoppage of the input device on the display.

21. The system of claim 20, wherein masking cursor motion associated with motion stoppage of the input device on a display further comprises:
the device further configured to predictively capture an ending position of the cursor when masking cursor motion associated with motion stoppage of the input device on the display.

22. The system of claim 13, further comprising:
the device configured to reduce an overshoot distance wherein the overshoot distance is a distance the cursor moves on the display after the input device stops moving by using a prediction equation which includes a scaling function.

23. The system of claim 13, wherein the input device is a 3D pointing device.

24. The system of claim 13, wherein the device is at least one of a set-top box, a gaming console, a system controller, a personal controller and the input device.

25. A method for masking latency associated with displaying a graphic on a display, the method comprising:
receiving data associated with motion of at least one object at a first time;
using the data to determine a position associated with the first time;
determining a predicted position at a future time relative to the first time using the determined position; and
displaying the graphic on the display screen at a position based on the predicted position.

26. The method of claim 25, wherein determining the predicted position further comprises:
using a double exponential smoothing algorithm which includes a data smoothing factor and a trend smoothing factor.

27. The method of claim 25, wherein the at least one object is a head mounted display used in at least one of an augmented reality system and a virtual reality system.

28. The method of claim 27, wherein a point of view is a 2D point of view.

29. The method of claim 28, further comprising:
displaying a marker which indicates a center of the point of view.

30. The method of claim 28, further comprising:
displaying an independent cursor, wherein a displayed position of the cursor is based on a predicted cursor position.

31. The method of claim 27, wherein a point of view is a 3D point of view.

32. The method of claim 31, further comprising:
displaying a marker which indicates a center of the point of view.

33. The method of claim 31, further comprising:
displaying an independent cursor, wherein a displayed position of the cursor is based on a predicted cursor position.

34. The method of claim 25, wherein determining the predicted position further comprises:
processing raw sensor data into three-dimensional (3D) quaternion position information;
predicting a future quaternion; and
mapping 3D data to two dimensional (2D) data.
